(19) United States
(12) Patent Application Publication
(10) Pub. No.: US 2025/0300575 A1
(43) Pub. Date: Sep. 25, 2025

(54) ADAPTIVE CONTROL FOR MULTI-LEVEL CONVERTERS

(71) Applicant: TEXAS INSTRUMENTS INCORPORATED, Dallas, TX (US)

(72) Inventors: Riccardo Ruffo, Freising (DE); Ivana Santrac, Freising (DE); Kelvin Le, Dallas, TX (US)

(21) Appl. No.: 18/816,768

(22) Filed: Aug. 27, 2024

Related U.S. Application Data
(60) Provisional application No. 63/569,243, filed on Mar. 25, 2024.

(51) Int. Cl. H02M 7/483; H02M 7/5395

(52) U.S. Cl. CPC H02M 7/4835; H02M 7/5395

(57) ABSTRACT

A method includes receiving a feedback signal associated with a multi-level converter circuit. The multi-level converter circuit includes a two-level converter circuit and a higher-level converter circuit. The higher-level converter circuit increases a number of levels associated with the multi-level converter circuit to more than two levels provided by the two-level converter circuit. The method also includes generating at least one control signal for controlling at least one switch of the two-level converter circuit based on the feedback signal. The method further includes generating at least another control signal for controlling at least another switch of the higher-level converter circuit based on the feedback signal.

### RELATED APPLICATIONS

The instant application is a nonprovisional patent application that claims the benefit and priority to the U.S. Provisional Application No. 63/569,243, filed on Mar. 25, 2024, which is incorporated herein by reference in its entirety.

### BACKGROUND

High power applications have increased in recent years. For example, the increase in the number of electric vehicles (EV), renewable energy generation such as solar powers, battery backup for solar panels, etc., has resulted in an increased number of high-power applications such as battery charging/discharging. Many high-power applications use traction inverters to convert a direct current (DC) to alternating current (AC). Some have used a 3-level T-type converters (a 3-level T-type converter is a 3-level bidirectional power converter topology that converts a DC voltage to AC voltage or vice versa and that can operate as an inverter or a power factor correction device) or higher than 3-level converters such as 4-level converters, to improve efficiency and electromagnetic interference (EMI) in comparison to lower-level converters such as 2-level converters.

Multi-level converters such as 3-level converters use more power switches in comparison to 2-level converters, thereby increasing the cost. Power switches are low resistance between drain-source when switch is on (RDSON), e.g., 5 mΩ, to support high current drives, e.g., 400 Amp. In general, in a T-type converter the outer power switches are rated for a full V_{bus} voltage such as 1200V for an 800V V_{bus} whereas the middle power switches can be rated for half of that such as 600V for an 800 V_{bus}. However, the current rating for the middle power switches and the outer power switches is still the same. Accordingly, low RDSON for the middle power switches are still needed in order to address the current rating even though the middle power switches can be rated for half of the full V_{bus} voltage. Accordingly, the cost associated with transitioning to a T-type converter is further increased due to low RDSON rating associated with the middle power switches.

### SUMMARY

In an example, an apparatus includes a two-level converter circuit, a higher-level converter circuit, and a controller. The higher-level converter circuit increases a number of levels to more than two levels provided by the two-level converter circuit. The controller is configured to receive a feedback signal associated with the two-level converter circuit and the higher-level converter circuit. The controller is configured to generate at least one control signal for controlling at least one switch of the 2-level converter circuit based on the feedback signal. The controller is further configured to generate at least another control signal for controlling at least another switch of the higher-level converter circuit based on the feedback signal.

In an example, a method includes receiving a feedback signal associated with a multi-level converter circuit. The multi-level converter circuit includes a two-level converter circuit and a higher-level converter circuit. The higher-level converter circuit increases a number of levels associated with the multi-level converter circuit to more than two levels provided by the two-level converter circuit. The method further includes generating at least one control signal for controlling at least one switch of the two-level converter circuit based on the feedback signal. The method also includes generating at least another control signal for controlling at least another switch of the higher-level converter circuit based on the feedback signal.

### BRIEF DESCRIPTION OF THE DRAWINGS

FIG. 1 is a schematic diagram of an adaptive control system for a multi-level converter, in an example.

FIG. 2 is a schematic diagram of a multi-level converter, in an example.

FIG. 3 is a schematic diagram of a control system for generating a control signal for a power switch in a multi-level converter of FIG. 2, in an example.

FIG. 4 is a schematic diagram of another control system for generating a control signal for a power switch in a multi-level converter of FIG. 2, in an example.

FIG. 5 is a schematic diagram of an electric vehicle system with adaptive control for a multi-level converter, in an example.

FIG. 6 is schematic diagram of a 3-phase 3-level T-type inverter, in an example.

FIG. 7 is a comparison of a performance between a conventional multi-level converter and a hybrid multi-level converter, in an example.

FIG. 8 is a relation between conduction loss and junction temperature, in an example.

FIGS. 9A-9C are a comparison of performance between a conventional multi-level converter and a hybrid multi-level converter at a plurality of junction temperatures, in an example.

### DETAILED DESCRIPTION

The same reference numbers or other reference designators are used in the drawings to designate the same or similar (either by function and/or structure) features. Before various examples are described in greater detail, it should be understood that the examples are not limiting, as elements in such examples may vary. It should likewise be understood that a particular example described and/or illustrated herein has elements which may be readily separated from the particular example and optionally combined with any of several other examples or substituted for elements in any of several other examples described herein. It should also be understood that the terminology used herein is for the purpose of describing certain concepts, and the terminology is not intended to be limiting. Unless defined otherwise, all technical and scientific terms used herein have the same meaning as commonly understood in the art to which the examples pertain.

An adaptive control mechanism may be used to control the operation of a multi-level converter such that the multi-level converter can operate as a multi-level or a lower-level (e.g., hybrid mode) converter to improve efficiency and also to reduce cost. For example, a 3-level T-type converter may be operated in a 2-level or 3-level, as desired, to improve its efficiency and EMI. The cost associated with the 3-level T-type converter may be reduced by allowing the middle power switches of the T-type converter to be replaced with lower cost switches (e.g., high RDSON such as 20-40 mΩ) instead of having to be rated for high current (e.g., low RDSON such as 2-6 mΩ) of a conventional 3-L type converters. According to an example, a feedback signal (e.g., switching terminal current, junction temperature, etc.) associated with the middle power switches may be used to generate a control signal (e.g., pulse width modulation (PWM)) for controlling each switch (e.g., one or more switches of the middle power switches and/or the outer power switches) of the T-type converter.

It is appreciated that throughout this application, the examples are provided with respect to a 3-level T-type converter for illustration purposes and should not be construed as limiting the scope of the examples. For example, the discussion with respect to a 3-level converter in a T-type converter is equally applicable to 4-level or higher-level converters that may or may not be in a T-type configuration.

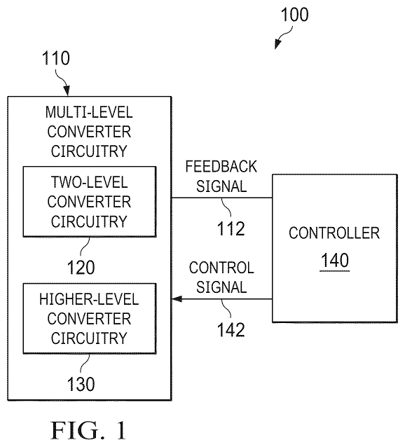

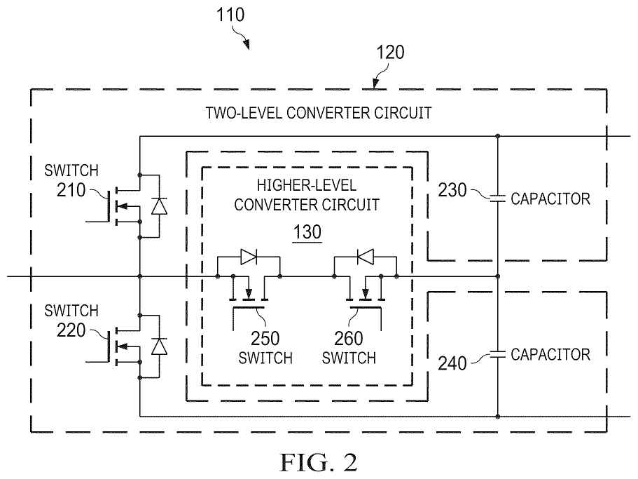

FIG. 1 is a schematic diagram of an adaptive control system 100 for a multi-level converter, in an example. The system 100 includes a multi-level converter circuitry 110 coupled to a controller 140. The multi-level converter circuitry 110 includes a two-level (2-level) converter circuitry 120 and a higher-level converter circuitry 130. According to an example, the 2-level converter circuitry 120 is a converter with two levels and the higher-level converter circuitry 130 is a circuitry that changes the 2-level converter circuitry 120 to a higher-level converter, e.g., 3-level, 4-level, etc. In one example, the 2-level converter circuitry 120 includes power switches (also referred to as outer power switches) and the higher-level converter circuitry 130 includes power switches (also referred to as middle power switches), as described in greater detail in FIG. 2. In one example, the multi-level converter circuitry 110 may be a 3-level T-type converter. The multi-level converter circuitry 110 may generate a feedback signal 112 (e.g., switching terminal current, junction temperature, etc.) that is used by the controller 140, e.g., a central processor unit (CPU), a microcontroller, a field programmable gate array (FPGA), application specific integrated circuit (ASIC), etc., to generate a control signal 142 (e.g., a PWM signal) for controlling one or more power switches of the multi-level converter circuitry 110.

It will be apparent that the components portrayed in this figure and subsequent figures can be arbitrarily combined or divided into separate software, firmware and/or hardware components. Furthermore, it will also be apparent that such components, regardless of how they are combined or divided, can execute on the same host or multiple hosts, and wherein the multiple hosts can be connected by one or more networks.

Referring now to FIG. 2, a schematic diagram of a multi-level converter 110, in an example, is shown. The multi-level converter 110 in the example of FIG. 2 is a 3-level T-type 1-phase converter circuit. The multi-level converter 110 includes a 2-level converter circuit 120 that includes power switches 210-220 (outer power switches) and capacitors 230-240. The higher-level converter circuit 130 in FIG. 2 is a circuitry that converts the 2-level converter circuit 120 to a 3-level converter circuit and it includes power switches 250 and 260 (middle power switches). The power switches 250 and 260 are positioned in between the power switches 210 and 220 and capacitors 230 and 240 of the 2-level converter circuit 120.

In one example, the feedback signal 112 may be a signal associated with the switching terminal current of the higher-level converter circuit 130. For example, the feedback signal 112 in FIG. 2 may be the switching terminal current of the power switches 250 and 260 of the higher-level converter circuit 130. In one example, the switching terminal current may be measured using an inductor (not shown) connected to the power switches 250 and 260. In yet another example, the feedback signal 112 in FIG. 2 may be the junction temperature associated with the power switches 250-260 of the higher-level converter circuit 130. According to one example, the junction temperature may be measured using a diode or by a GaN device that may be responsible for power conversion that is also capable of measuring the temperature. In one example, temperature may be measured internally in the power device using a temperature sensor or may be estimated by measuring parameters, e.g., real time measuring of RDSON, associated with a switch, e.g., FET. In one example, the GaN device or the diode may measure the junction temperature associated with a power switch 250 and/or 260. The feedback signal 112 that may include the switching terminal current and/or junction temperature is sent to the controller 140 for processing.

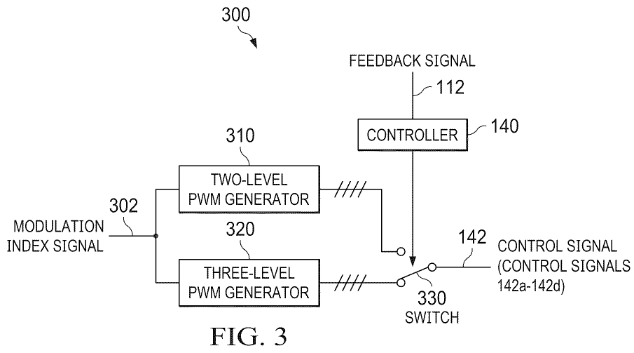

FIG. 3 is a schematic diagram of a control system 300 for generating a control signal for a power switch in a multi-level converter of FIG. 2, in an example. The control system 300 includes a 2-level PWM generator 310, a 3-level PWM generator 320, the controller 140 and a switch 330. In one example, the modulation index signal 302 is input to the 2-level PWM generator 310 to generate a PWM signal associated with the converter when operating in the 2-level mode. The modulation index signal 302 is input to the 3-level PWM generator 320 to generate a PWM signal associated with the converter when operating the 3-level mode. In an example where a higher-level converter is implemented, e.g., 4-level, etc., additional PWM generators may also be present. The controller 140 that receives the feedback signal 112 controls the switch 330 (e.g., turning it on/off) to output a 2-level PWM signal or a 3-level PWM signal as control signal 142. According to some examples, the 2-level and 3-level modes may be performed within a same cycle of the sinusoidal waveform that is being controlled, e.g., a 3-L PWM signal is used for current peak up to 40 Amp and a 2-L PWM signal is used for current peak from 40-200 Amp. According to one example, one PWM generator may be used to generate a desired PWM signal instead of selecting between the 2-level PWM generator 310 and the 3-level PWM generator 320.

In this example, for a 3-level converter with four power switches, four control signals may be output (one for each power switch). For example, one control signal may be generated to control the power switch 210, one control signal may be generated to control the power switch 220, one control signal may be generated to control the power switch 250, and one control signal may be generated to control the power switch 260. As such, the 2-level PWM generator 310 may generate four PWM signals (one for each power switch) and the 3-level PWM generator 320 may generate four PWM signals (one for each power switch). The controller 140 controls the switch 330 to generate four control signals (one for each power switch 210-220 and 250-260) that is referred to herein as control signal 142 (but may include multiple control signals).

Discussions with respect to one control signal for each power switch is for illustrative purposes and should not be construed as limiting the scope of the examples. For example, one control signal may be used to control the operation of power switches (e.g., switches 210-220) of the 2-level converter circuit 120 while one control signal may be used to control the operation of the power switches (e.g., switches 250-260) of the higher-level converter circuit 130.

In one example, a memory component may be used to store a lookup table (LUT) that is accessed by the controller 140 to determine the control signal 142. The LUT may be stored and implemented to improve efficiency by determining the PWM signal associated with a particular power switch based on the feedback signal 112. For example, the LUT may have a corresponding PWM signal (for a given power switch such as switch 210 or 220 or 250 or 260) associated with a particular feedback signal (e.g., switching terminal current and/or junction temperature, etc.). In other words, the LUT may indicate a particular PWM signal to be used for a given switch (e.g., switch 210, switch 220, switch 250, switch 260) based on the feedback signal (e.g., based on a switching terminal current and/or junction temperature). Below is an example of a table associated with switch 210. A similar table may be used for other power switches of the multi-level converter circuitry. According to one example, the LUT associated with each power switch may be the same or different from one another. In other words, controlling each power switch may be programmable (via the LUT) and the operation of each power switch may be controlled independent of other power switch and based on the feedback signal.

| Feedback Signal (switching terminal | PWM |
|---|---|
| current, junction temperature, etc.) | Signal |
| a₁ | PWM₁ |
| a₂ | PWM₂ |
| a₃ | PWM₃ |
| . . . | . . . |
| aₙ | PWMₙ |

According to one example, based on the determined PWM signal, the controller 140 controls the switch 330 to output the desired PWM signal, as the control signal 142. The control signal 142 is sent to the multi-level converter 110 in order to control the operation of the power switches (hybrid mode). In one example, the control signal 142 may include multiple signals (e.g., control signals 142a, 142b, 142c, and 142d) to control multiple power switches.

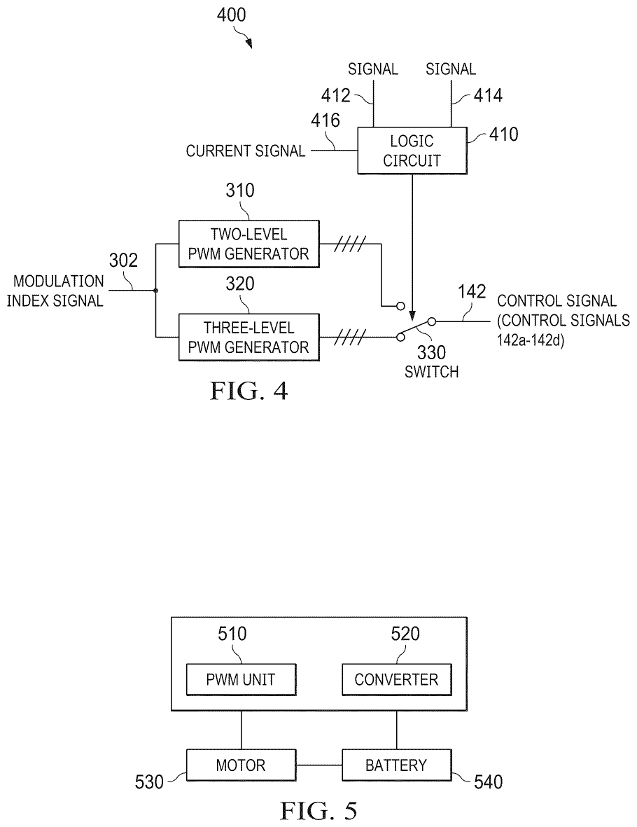

FIG. 4 is a schematic diagram of another control system 400 for generating a control signal for a multi-level converter of FIG. 2, in an example. FIG. 4 is similar to FIG. 3 except that a logic circuit 410 is used instead of the controller 140. The logic circuit 410 may include one or more logical circuits (e.g., AND gate, OR gate, NOR gate, XOR gate, etc.). The logic circuit 410 may receive the current signal 416 and signals 412-414 as its feedback signal. The current signal 416 is a signal associated with the switching terminal current, as described above. The signals 412 and 414 may be signals associated with junction temperatures of power switches 250 and 260 respectively. The logic circuit 410 based on the received signals (e.g., current signal 416 and/or signal 412 and/or signal 414) controls the operation of the switch 330 to generate the appropriate PWM signal for each power switch, as the control signal 142 (e.g., control signals 142a-142d).

It is appreciated that the control systems 300 or 400, as described above, may be replicated for each phase of the system. For example, in a 1-phase converter each of the control systems may be replicated twice whereas in a 3-phase converter each of the control systems may be replicated three times.

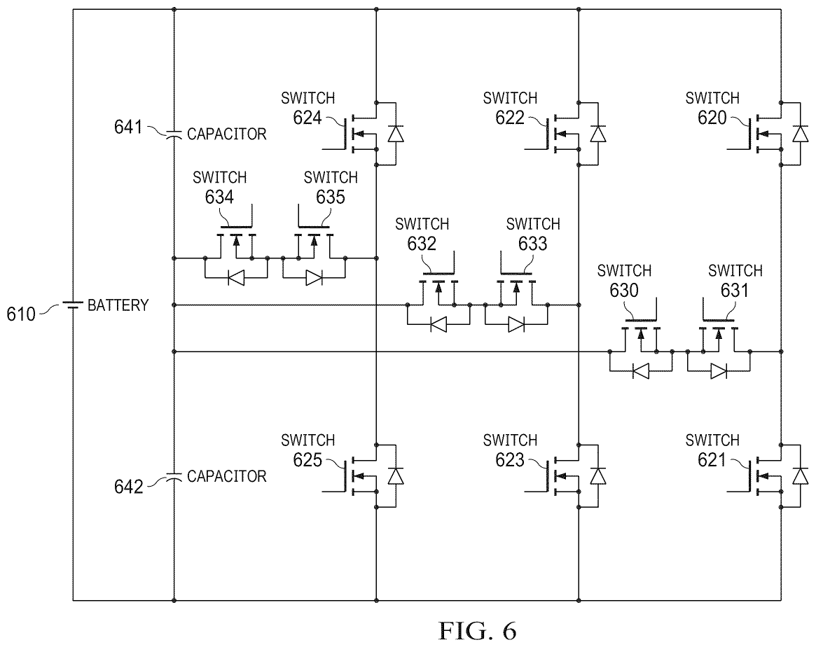

FIG. 5 is a schematic diagram of an electric vehicle system with adaptive control for a multi-level converter, in an example. The EV system may include a PWM unit 510, a converter 520, a motor 530 and a battery 540. The PWM unit 510 may be similar to the system 300 or 400 of FIG. 3 or 4 respectively to generate a control signal associated with power switches of the converter 520 circuitry (e.g., multi-level converter circuitry 11. The battery 540 is an electric storage for supplying power for the motor 530. The PWM unit 510 and the converter 520 may be traction inverters for the EV.

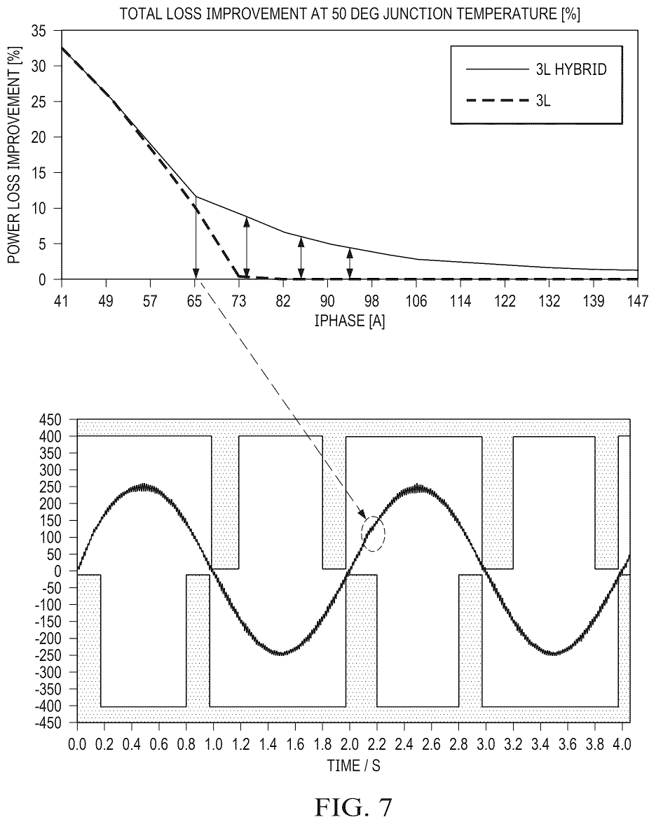

FIGS. 1-5 described 1-phase converters for illustration purposes that should not be construed as limiting the scope. For example, FIG. 6 is schematic diagram of a 3-phase 3-level T-type inverter, in an example. In FIG. 6, the outer power switches 620-625 are associated with the 2-level converter circuitry whereas the middle power switches 630-635 are associated with the higher-level converter circuitry (e.g., 3-level). In an example, the 3-phase 3-level T-type inverter may also include capacitors 641 and 642 and a battery 610.

According to an example, a PWM signal (control signal) may be generated for each power switch, e.g., switches 621-635 in FIG. 6. In other words, 12 PWM signals may be generated, one for each power switch. In another example, one control signal may be generated to control switches 634-635, one control signal may be generated to control switches 632-633, one control signal may be generated to control switches 630-631, one control signal may be generated to control switch 620, etc. In yet another example, one control signal may be generated to control more than one of the outer power switches, e.g., switches 621-625.

According to one example, the feedback signal may include one or more of switching current terminal for switches 634-635, switching current terminal for switches 632-633, switching current terminal for switches 630-631, junction temperature for switch 630, junction temperature for switch 631, junction temperature for switch 632, junction temperature for switch 633, junction temperature for switch 634, junction temperature for switch 635, etc. Accordingly, the number of feedback signals, the type of feedback signals, etc., may be changed as desired to control the operation of each power switch. In other words, the number of feedback signals, the type of feedback signals, the number of control signals, etc., is configurable and controllable to control the operation of one or more power switches of the converter circuitry.

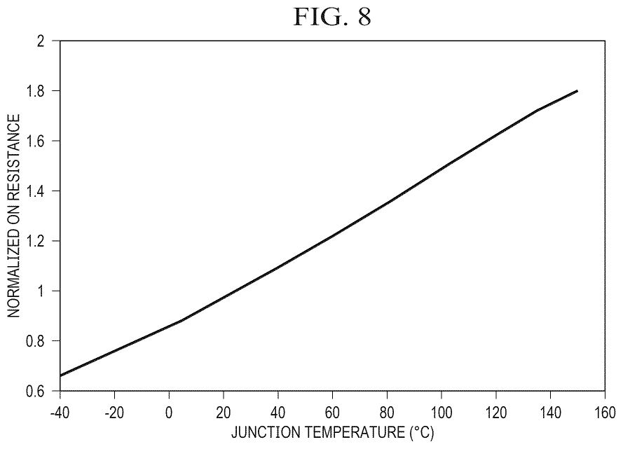

FIG. 7 is a comparison of a performance between a conventional multi-level converter and a hybrid multi-level converter, in an example. FIG. 7 illustrates that at 50 degrees junction temperature under conventional 3-level converter, the power loss is substantially reduced but once a current threshold is reached, power loss increases and it is not efficient to be driven in the 3-L mode. In comparison, the hybrid 3-level system, as described in FIGS. 1-6, results in further reduction of power loss at high loads. As illustrated, in one example, the converter may be operated in 3-level operation until the 65 Amp threshold, and at which point the power loss cannot be reduced under 3-level operation. As such, the system controls the power switches to operate in 2-level operation at or above 65 Amp in one example mixed with 3-level operation (i.e., hybrid mode) when appropriate to achieve further reduction in power loss, as shown. The results at 50 degree junction temperature are provided for illustration purposes and should not be construed as limiting the scope of the examples. According to some examples, at light loads, the hybrid 3-level operation may improve efficiency up to 30% and at heavy loads it may improve efficiency to 5%.

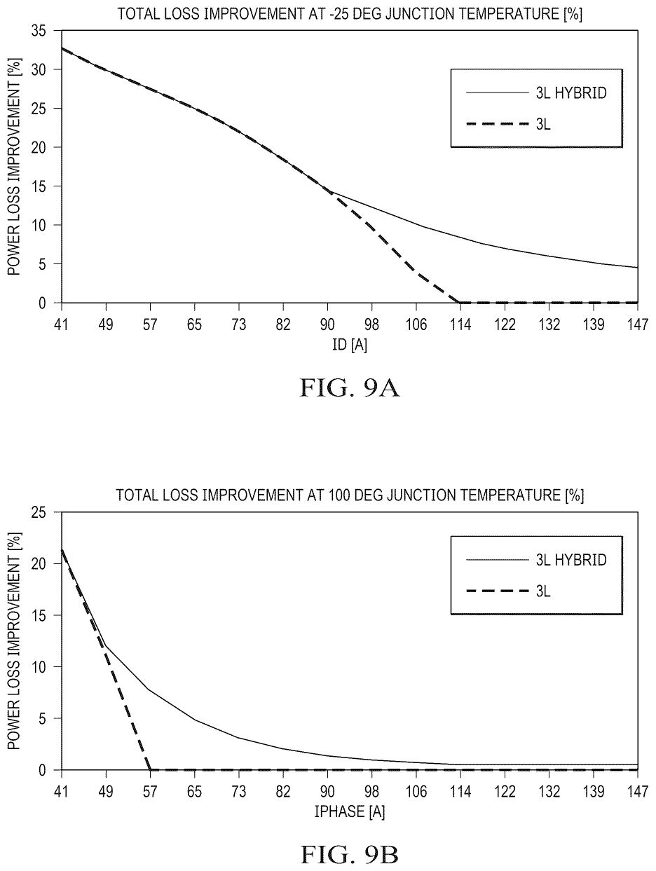

FIG. 8 is a relation between conduction loss and junction temperature for a GaN device, in an example. As illustrated, conduction losses are dependent on the junction temperature in GaN devices. As such, monitoring the junction temperature in real time and controlling the operation of power switches (using PWM signals) enables efficiency and EMI to be improved and further to allow longer 3-level regulation even at a high load. It is appreciated that the terms operation, regulation, and mode have been used throughout this application interchangeably.

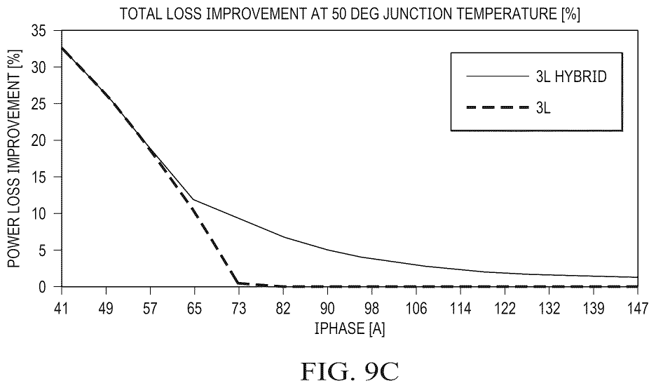

FIGS. 9A-9C are a comparison of performance between a conventional multi-level converter and a hybrid multi-level converter at a plurality of junction temperatures, in an example. Reduction in power loss at −25, 100, and 50 degrees Celsius junction temperatures for 3-level converter as opposed to 3-level converter capable of operating in a hybrid mode is shown. As illustrated, the 3-level operation region is extended as well as enabling overloading depending on the junction temperature. In other words, the threshold current associated with 2 level or 3 level operating point may be changed depending on the junction temperature. As such, if the junction temperature is low the RDSON is low and the threshold current may be increased. If the threshold is increased, the device may be operated in 3 level operation mode longer, thereby increasing overall efficiency.

Accordingly, the real time current (switching terminal current) from one or more power switches (e.g., middle power switches) and/or one or more junction temperature associated with one or more power switches (e.g., middle power switches) may be used control the operation of the power switches (e.g., middle power switches and/or outer power switches) to operate the converter in a partial 3-level T-type over the full range of loads, thereby improving the efficiency. In other words, the hybrid operation enables the system to extend its operation in 3-level operation in comparison to the conventional 3-level mode, thereby reducing power losses. The hybrid operation may occur within an electrical cycle depending on the current and/or temperature provided as the feedback signal. Controlling the operation of the converter in a hybrid mode enables the middle power switches to be rated for lower current (e.g., high RDSON), thereby reducing the cost while still enabling high efficiencies, lower EMI, and less partial discharge (on the motor side) to be achieved. In one example, in a motor application, the hybrid mode enables the DC current in the motor to be in a low speed/stalling condition while the junction temperature and/or current is used to switch in 3-level until an appropriate temperature threshold is reached. According to an example, the hybrid operation, as described above, is used at lower operating temperature to improve battery efficiency. According to an example, the middle power switches may operate at high current even though they may not be rated for high current, as described above, thereby reducing the cost. In other words, even when the phase current has a high amplitude, the middle power switches may operate for a certain period of time within one cycle.

In this description, the term “couple” may cover connections, communications, or signal paths that enable a functional relationship consistent with this description. For example, if device A generates a signal to control device B to perform an action: (a) in a first example, device A is coupled to device B by direct connection; or (b) in a second example, device A is coupled to device B through intervening component C if intervening component C does not alter the functional relationship between device A and device B, such that device B is controlled by device A via the control signal generated by device A.

Also, in this description, the recitation “based on” means “based at least in part on.” Therefore, if X is based on Y, then X may be a function of Y and any number of other factors.

A device that is “configured to” perform a task or function may be configured (e.g., programmed and/or hardwired) at a time of manufacturing by a manufacturer to perform the function and/or may be configurable (or reconfigurable) by a user after manufacturing to perform the function and/or other additional or alternative functions. The configuring may be through firmware and/or software programming of the device, through a construction and/or layout of hardware components and interconnections of the device, or a combination thereof.

Modifications are possible in the described embodiments, and other embodiments are possible, within the scope of the claims.

What is claimed is:

1. An apparatus comprising:
a two-level converter circuit;
a higher-level converter circuit, wherein the higher-level converter circuit increases a number of levels to more than two levels provided by the two-level converter circuit; and
a controller configured to receive a feedback signal associated with the two-level converter circuit and the higher-level converter circuit,
wherein the controller is configured to generate at least one control signal for controlling at least one switch of the two-level converter circuit based on the feedback signal, and
wherein the controller is configured to generate at least another control signal for controlling at least another switch of the higher-level converter circuit based on the feedback signal.

2. The apparatus of claim 1, wherein the feedback signal is an amount of current being drawn by the two-level converter circuit and the higher-level converter circuit.

3. The apparatus of claim 1, wherein the feedback signal is associated with a temperature associated with the at least another switch of the higher-level converter circuit.

4. The apparatus of claim 1, wherein the at least one control signal is a pulse width modulation (PWM) signal.

5. The apparatus of claim 1, wherein the at least another control signal is a pulse width modulation (PWM) signal.

6. The apparatus of claim 1, wherein the at least one control signal and the at least another control signal cause the two-level converter circuit and the higher-level converter circuit to operate in a hybrid modulation mode.

7. The apparatus of claim 1 further comprising accessing a memory component configured to store a lookup table (LUT), wherein the controller is configured to] access the LUT to generate the at least one control signal and the at least another control signal.

8. The apparatus of claim 1, wherein the at least one switch of the two-level converter circuit is rated to support current to approximately 200-400 Amp and has a resistance between drain-source when the at least one switch of the two-level converter circuit is on (RDSON) of approximately 2-6 mΩ and wherein the at least another switch of the higher-level converter circuit has RDSON of approximately 20-40 mΩ.

9. The apparatus of claim 1, wherein the controller is a pulse width modulation (PWM) unit.

10. The apparatus of claim 1, wherein the controller is configured to generate a pulse width modulation (PWM) signal associated with each power switch within the two-level converter circuit and the higher-level converter circuit.

11. The apparatus of claim 1, wherein the two-level converter circuit is a three-phase circuit.

12. The apparatus of claim 1, wherein the higher-level converter circuit is a T-type converter.

13. A method comprising:
receiving a feedback signal associated with a multi-level converter circuit, wherein the multi-level converter circuit includes a two-level converter circuit and a higher-level converter circuit, wherein the higher-level converter circuit increases a number of levels associated with the multi-level converter circuit to more than two levels provided by the two-level converter circuit;
generating at least one control signal for controlling at least one switch of the two-level converter circuit based on the feedback signal; and
generating at least another control signal for controlling at least another switch of the higher-level converter circuit based on the feedback signal.

14. The method of claim 13, wherein the feedback signal is a current being drawn by the multi-level converter circuit.

15. The method of claim 13, wherein the feedback signal is associated with a temperature associated with the at least another switch of the higher-level converter circuit.

16. The method of claim 13, wherein the at least one controls signal is a pulse width modulation (PWM) signal.

17. The method of claim 13, wherein the at least another control signal is a pulse width modulation (PWM) signal.

18. The method of claim 13, wherein the at least one control signal and the at least another control signal cause the two-level converter circuit and the higher-level converter circuit to operate in a hybrid modulation mode.

19. The method of claim 13 further comprising accessing a memory component to determine a value associated with the at least one control signal and further to determine a value associated with the at least another control signal.

20. The method of claim 19, wherein the memory component is a look-up table (LUT).

21. The method of claim 13, wherein the at least one switch of the two-level converter circuit is rated to support current to approximately 200-400 Amp and has a resistance between drain-source when the at least one switch of the two-level converter circuit is on (RDSON) of approximately 2-6 mΩ and wherein the at least another switch of the higher-level converter circuit has RDSON of approximately 20-40 mΩ.
